(19) United States
(12) Patent Application Publication
(10) Pub. No.: US 2025/0337127 A1
(43) Pub. Date: Oct. 30, 2025

(54) BATTERY ASSEMBLY STRUCTURE

(71) Applicant: Isuzu Motors Limited, Yokohama-shi (JP)

(72) Inventors: Kazuhiro UEDA, Fujisawa-shi (JP); Hiroshi YAMADA, Fujisawa-shi (JP); Shuhei KONISHI, Fujisawa-shi (JP)

(73) Assignee: Isuzu Motors Limited, Yokohama-shi (JP)

(21) Appl. No.: 19/058,064

(22) Filed: Feb. 20, 2025

(30) Foreign Application Priority Data
Apr. 30, 2024 (JP) 2024-073931

(51) Int. Cl. H01M 50/517; H01M 50/271; H01M 50/296; H01M 50/507; H01R 4/30

(52) U.S. Cl. CPC H01M 50/517; H01M 50/271; H01M 50/296; H01M 50/507; H01R 4/30; H01M 2220/20

(57) ABSTRACT

A battery assembly structure includes: a battery case including an accommodation part configured to accommodate a battery pack; a battery cover including a wall part covering the accommodation part, and an opening part extending through the wall part; a connector disposed on an outer surface side of the wall part; and a bus bar disposed on an inner surface side of the wall part and configured to electrically connect the connector and a terminal disposed in the battery pack. In a case where the battery cover is assembled to the battery case such that the accommodation part is covered by the wall part, the opening part is disposed in a position in which the bus bar and the terminal are visible through the opening part from the outer surface side of the wall part.

### CROSS REFERENCE TO RELATED APPLICATIONS

This application claims the benefit of priority of Japanese Patent Application No. 2024-073931 filed on Apr. 30, 2024, the disclosure of which including the specification, drawings and abstract is incorporated herein by reference in its entirety.

### TECHNICAL FIELD

The present disclosure relates to a battery assembly structure.

### BACKGROUND ART

Vehicles such as electric vehicles and hybrid vehicles are equipped with an electric motor serving as a drive source and a battery serving as a power source for driving the electric motor.

The battery assembly structure includes, for example, a battery case, a battery cover, a connector, and a bus bar. The battery case includes an accommodation part that accommodates a battery pack. The battery pack includes a plurality of battery modules. The accommodation part is open on the front surface side. The battery cover includes a wall part. After the battery pack is accommodated in the accommodation part, the battery cover is assembled to the battery case such that the wall part covers the accommodation part from the front surface side. The battery connector is disposed on the outer surface side of the wall part. The bus bar is extended along the inner surface of the wall part and electrically connected to the battery connector. A terminal is disposed in the battery pack. The bus bar is electrically connected and fixed to the terminal. Further, a power harness extending from the battery module is electrically connected and fixed to the terminal. As described above, the battery connector is electrically coupled to the battery module via a bus bar, a terminal, and a power harness. Note that the battery connector is electrically connected to a vehicle-side connector. The vehicle-side connector is electrically connected to the electric motor side via a power harness.

For example, PTL 1 discloses a battery pack including: a lower battery module in which a plurality of battery cells are stacked; an upper battery module in which a plurality of battery cells are stacked; a plate part located between the upper battery module and the lower battery module; a first conductive part electrically connected to the lower battery module; a second conductive part electrically connected to the upper battery module; and a coupling part that electrically couples the first conductive part and the second conductive part, in which the plate part has an opening part extending through the plate part in an up-down direction, and the coupling part is located inside the opening part when viewed from above.

### CITATION LIST

### Patent Literature

### PTL 1

Japanese Patent Application Laid-Open No. 2021-044228

### SUMMARY OF INVENTION

### Technical Problem

In the battery assembly structure described above, the battery cover is assembled to the battery case such that the wall part covers the accommodation part from the front surface side. As a result, the operator cannot visually confirm the relative positional relationship between the bus bar extending along the inner surface of the wall part, and the terminal disposed in the battery pack. This makes it difficult to perform the connection work (wiring work) for electrically connecting the bus bar and the terminal. Further, if the wiring work is performed under an insufficient condition for the wiring work, the bus bar and the terminal may interfere with each other and may be damaged.

Further, in the battery pack disclosed in PTL 1, the opening part extends through in the up-down direction, and as such it is difficult to visually recognize, through the opening part, the relative positional relationship between the bus bar extending along the inner surface of the wall part and the terminal disposed in the battery pack. Therefore, it cannot be said that the conditions for the wiring work are sufficient, and it is not possible to easily perform the connection work for electrically connecting the bus bar and the terminal.

An object of the present disclosure is to provide a battery assembly structure that facilitates the connection work of electrically connecting a bus bar and a terminal.

### Solution to Problem

To achieve the above-described object, a battery assembly structure according to the present disclosure includes: a battery case including an accommodation part configured to accommodate a battery pack; a battery cover including a wall part covering the accommodation part, and an opening part extending through the wall part; a connector disposed on an outer surface side of the wall part; and a bus bar disposed on an inner surface side of the wall part and configured to electrically connect the connector and a terminal disposed in the battery pack. In a case where the battery cover is assembled to the battery case such that the accommodation part is covered by the wall part, the opening part is disposed in a position in which the bus bar and the terminal are visible through the opening part from the outer surface side of the wall part.

### Advantageous Effects of Invention

According to the present disclosure, it is possible to easily perform the connection work of electrically connecting a bus bar and a terminal.

### BRIEF DESCRIPTION OF DRAWINGS

FIG. 1 is a front view illustrating a battery assembly structure according to an embodiment of the present disclosure;

FIG. 2 is an exploded perspective view illustrating a battery assembly structure according to the embodiment of the present disclosure;

FIG. 3 is an exploded perspective view illustrating a battery assembly structure according to the embodiment of the present disclosure;

FIG. 4 is a view illustrating a bus bar and a terminal that are visible through an opening part in the embodiment of the present disclosure;

FIG. 5 is a view illustrating a bus bar, a terminal, and a fastener that are visible through the opening part in the embodiment of the present disclosure; and

FIG. 6 is a perspective view illustrating a bus bar, a terminal, and a fastener in the embodiment of the present disclosure.

### DESCRIPTION OF EMBODIMENTS

Hereinafter, an embodiment of the present disclosure will be described with reference to the drawings. The vehicle in the embodiment of the present disclosure is a commercial electric vehicle used for purposes such as cargo delivery, and includes a frame structure, an electric motor, and a battery for driving. However, the present disclosure is not limited to application in commercial electric vehicles and may also be applied to general electric vehicles. The battery for driving is a battery for supplying power to the electric motor.

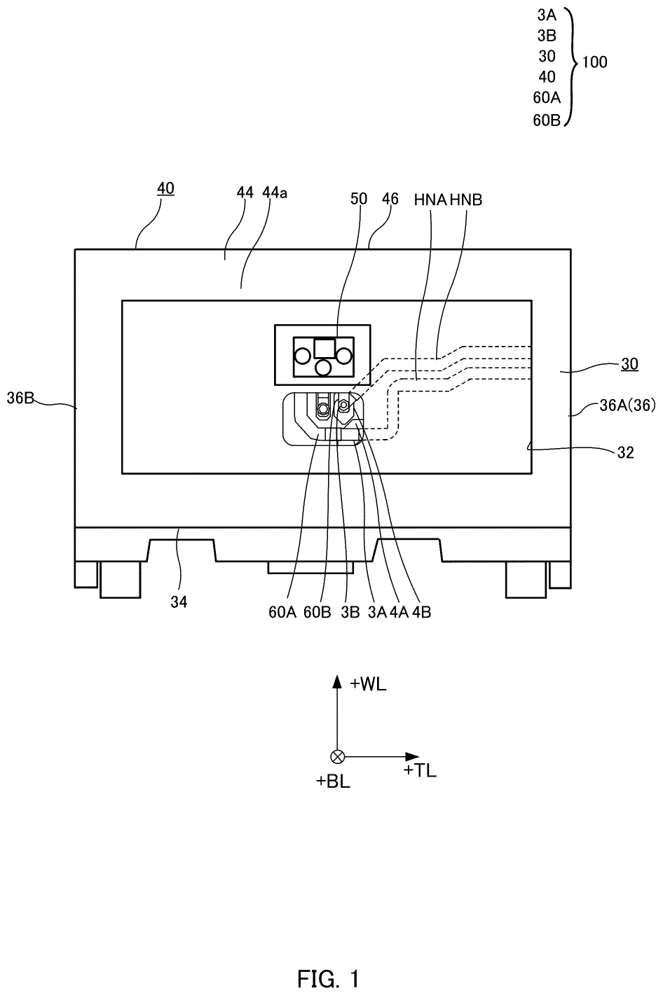

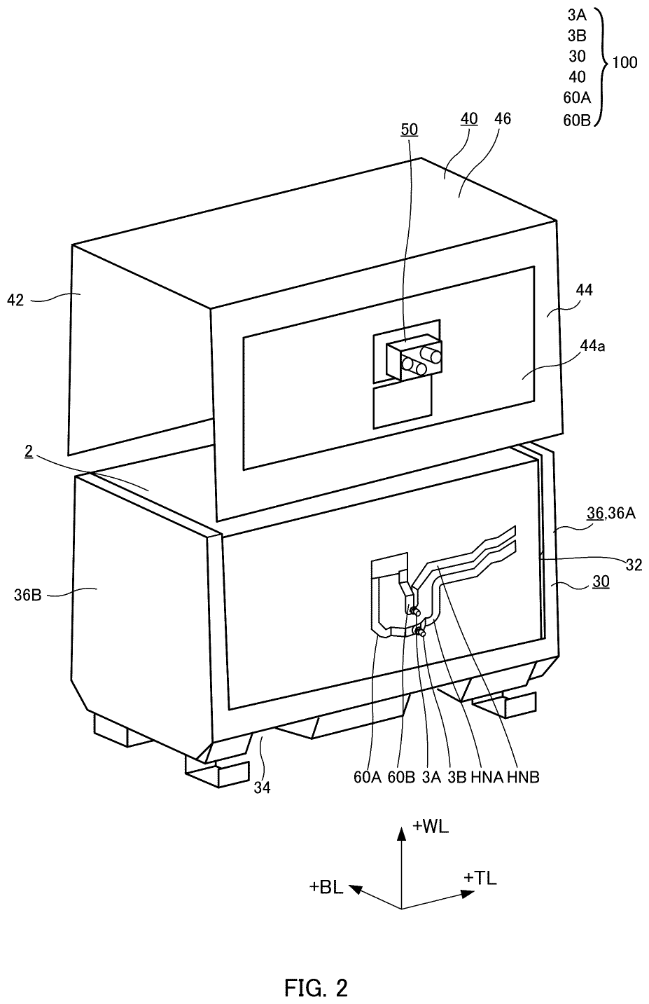

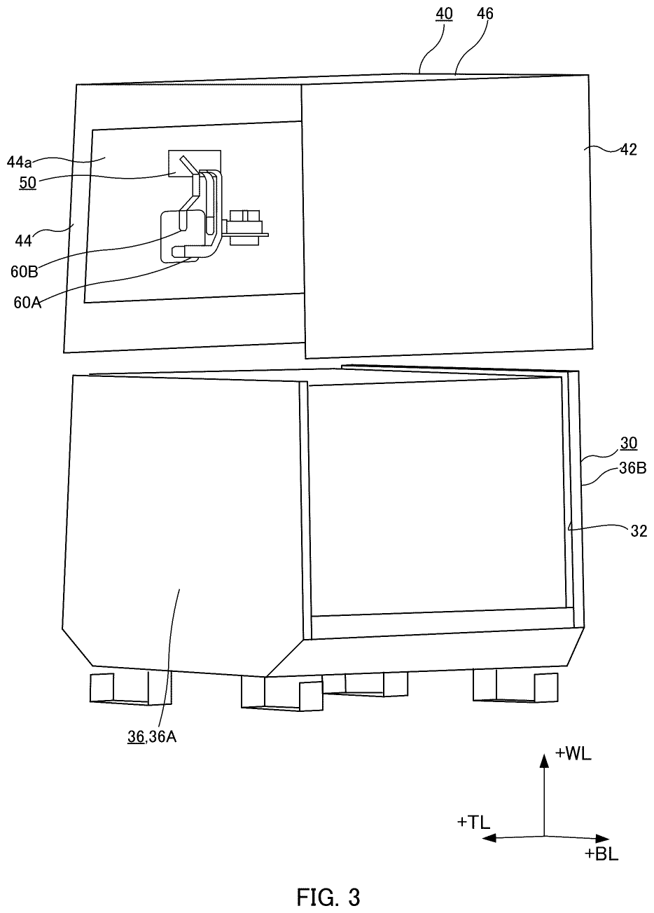

FIG. 1 is a front view illustrating a battery assembly structure according to the embodiment of the present disclosure. FIG. 2 is an exploded perspective view illustrating a battery assembly structure according to the embodiment of the present disclosure. FIG. 3 is an exploded perspective view illustrating a battery assembly structure according to the embodiment of the present disclosure. FIG. 1 illustrates the BL axis, the TL axis, and the WL axis. In the following description, the depth direction in FIG. 1 is referred to as the BL direction, the back direction is referred to as the back surface side or the “+BL direction”, and the front direction is referred to as the front surface side or the “−BL direction”. In FIG. 1, the left-right direction is referred to as the width direction or the TL direction, the right direction is referred to as one side in the width direction or the “+TL direction”, and the left direction is referred to as the other side in the width direction or the “−TL direction”. Further, in FIG. 1, the up-down direction is referred to as the height direction or the WL direction, the upward direction is referred to as the upper side or the “+WL direction”, and the downward direction is referred to as the lower side or the “−WL direction”. Note that the back surface side (+BL direction) and the front surface side (−BL direction) correspond to the “horizontal direction” in the present disclosure.

As illustrated in FIGS. 1, 2, and 3, battery assembly structure 100 in the embodiment of the present disclosure includes battery case 30, battery cover 40, battery connector 50, and bus bars 60A and 60B. FIG. 1 illustrates battery pack 2 and terminals 3A and 3B, and the like disposed on the front surface side of battery pack 2 when a part of the front surface side (−BL direction) of battery cover 40 are viewed in a see-through manner. FIG. 2 illustrates battery case 30, battery cover 40, and terminals 3A and 3B, and the like as viewed from an oblique front surface side. FIG. 3 illustrates battery case 30 and battery cover 40 as viewed from an oblique back surface side. Note that battery connector 50 corresponds to the “connector” in the present disclosure.

Battery pack 2 includes a plurality of battery modules (not illustrated), power harnesses HNA and HNB, a battery manager (not illustrated), and a junction box (not illustrated). The battery module includes a plurality of battery cells. The battery manager performs thermal management, charge/discharge management, and the like of the battery. Power harness HNA is connected to either the positive electrode (plus electrode) or the negative electrode (minus electrode) of the battery module via a junction box. Power harness HNB is connected to the other electrode of the battery module via a junction box.

Terminals 3A and 3B are disposed on the front surface side of battery pack 2. For example, each of terminals 3A and 3B is a rod-shaped screw terminal provided with a screw part provided on an outer periphery of the rod shape. Terminal 3A is fixed to battery pack 2 via terminal block 4A. Terminal 3B is fixed to battery pack 2 via terminal block 4B.

Terminal 3A is provided to protrude from battery pack 2 to the front surface side (−BL direction). Terminal 3A is electrically connected to the battery module via power harness HNA. Bus bar 60A (described later) is electrically connected to terminal 3A.

Terminal 3B is provided to protrude from battery pack 2 to the front surface side (−BL direction). Terminal 3B is electrically connected to the battery module via power harness HNB. Bus bar 60B (described later) is electrically connected to terminal 3B.

### Battery Case 30

Battery case 30 includes accommodation part 32 for accommodating battery pack 2.

Battery case 30 includes bottom wall part 34 on which battery pack 2 is placed, and both side wall parts 36. One side wall part 36 is side wall part 36A that is erected in the upward direction (+WL direction) from one end portion in the width direction of bottom wall part 34. The other side wall part 36 is side wall part 36B that is erected in the upward direction (+WL direction) from the other end portion in the width direction of bottom wall part 34. Battery case 30 does not include wall parts other than bottom wall part 34 and both side wall parts 36, i.e., wall parts on the front surface side (−BL direction), the back surface side (+BL direction), and the upper side (+WL direction). Thus, accommodation part 32 is open in the directions of the front surface side, the back surface side, and the upper side.

### Battery Cover 40

Battery cover 40 includes back surface side wall part 42, front surface side wall part 44, and upper side wall part 46. In a case where battery cover 40 is assembled to battery case 30, accommodation part 32 (battery pack 2) is covered from the directions of the front surface side, the back surface side, and the upper side. In the following description, the accommodation part 32 side of each of back surface side wall part 42, front surface side wall part 44, and upper side wall part 46 is referred to as the “inner surface side,” and the side opposite to the inner surface side is referred to as the “outer surface side.”

Specifically, in a case where battery cover 40 is assembled to battery case 30, back surface side wall part 42 is a wall that covers accommodation part 32 from the back surface side (+BL direction). Thus, the back surface side (+BL direction) of battery pack 2 cannot be visually recognized from the outer surface side of back surface side wall part 42. Further, front surface side wall part 44 is a wall that covers accommodation part 32 from the front surface side (−BL direction). Thus, the front surface side (−BL direction) of battery pack 2 and terminals 3A and 3B disposed on the front surface side of battery pack 2 cannot be visually recognized from the outer surface side of front surface side wall part 44. Further, upper side wall part 46 is a wall that covers accommodation part 32 from the upper side (+WL direction). Thus, the upper side (+WL direction) of battery pack 2 cannot be visually recognized from the outer surface side of upper side wall part 46.

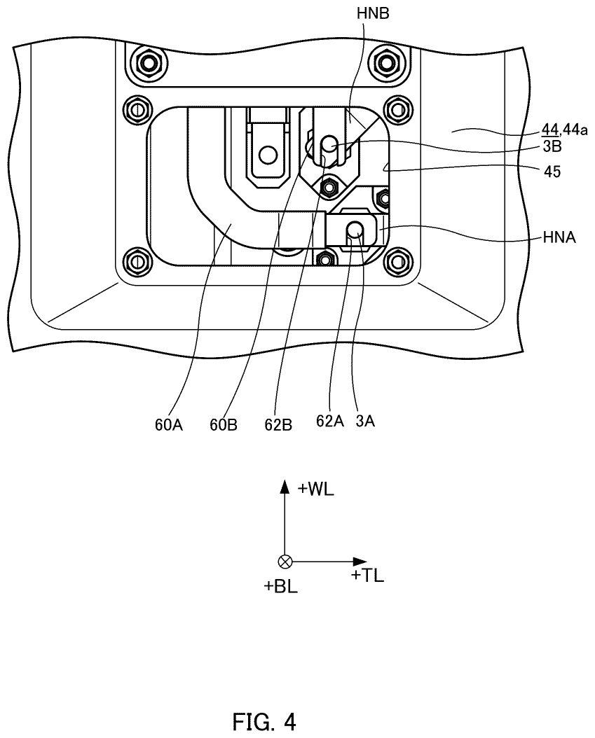

Front surface panel 44a is disposed at a central portion of front surface side wall part 44. Front surface panel 44a is provided with substantially rectangular opening part 45 that extends through it from the back surface side (+BL direction) to the front surface side (−BL direction). Opening part 45 (see FIG. 4) is disposed at a position where one end portion (end portion on the side connected to terminal 3A) of bus bar 60A (described later) is disposed, and at a position where one end portion (end portion on the side connected to terminal 3B) of bus bar 60B (described later) is disposed.

### Battery Connector 50

Battery connector 50 is disposed at front surface panel 44a. Battery connector 50 is a connector that connects a conductor. Battery connector 50 is disposed on the upper side (+WL direction) of opening part 45. Note that battery connector 50 is electrically connected to the vehicle-side connector. The vehicle-side connector is electrically connected to the electric motor side via a power harness (not shown).

### Bus Bars 60A and 60B

Bus bars 60A and 60B, which are conductors, are disposed along the inner surface side of front surface panel 44a. Bus bar 60A extends from battery connector 50 side to terminal 3A side, and electrically connects battery connector 50 and terminal 3A. Thus, battery connector 50 is connected to the battery module via bus bar 60A, terminal 3A, and power harness HNA. One end portion (end portion on the side connected to terminal 3A) of bus bar 60A includes fitting part 62A. Fitting part 62A is a concave groove in which the end edge of bus bar 60A is recessed in the upward direction (+WL direction). The shape of the concave groove (for example, the groove width or the groove depth) is set according to the size of terminal 3A (for example, the outer diameter of the rod shape). Fitting part 62A fits to terminal 3A from the upward direction. Note that the concave groove corresponds to the “recess part” in the present disclosure.

Bus bar 60B extends from battery connector 50 side to terminal 3B side, and electrically connects battery connector 50 and terminal 3B. Thus, battery connector 50 is connected to the battery module via bus bar 60B, terminal 3B, and power harness HNB. One end portion of bus bar 60B (the end portion on the side connected to terminal 3B) includes fitting part 62B. Fitting part 62B is a concave groove in which the end edge of bus bar 60B is recessed in the upward direction (+WL direction). The concave groove of bus bar 60B has the same configuration as that of the concave groove of bus bar 60A. That is, the shape of the concave groove (for example, the groove width or the groove depth) is set according to the size of terminal 3B (for example, the outer diameter of the rod shape). Fitting part 62B fits to terminal 3A from the upward direction. Note that the concave groove corresponds to the “recess part” in the present disclosure.

### Location of Opening Part 45

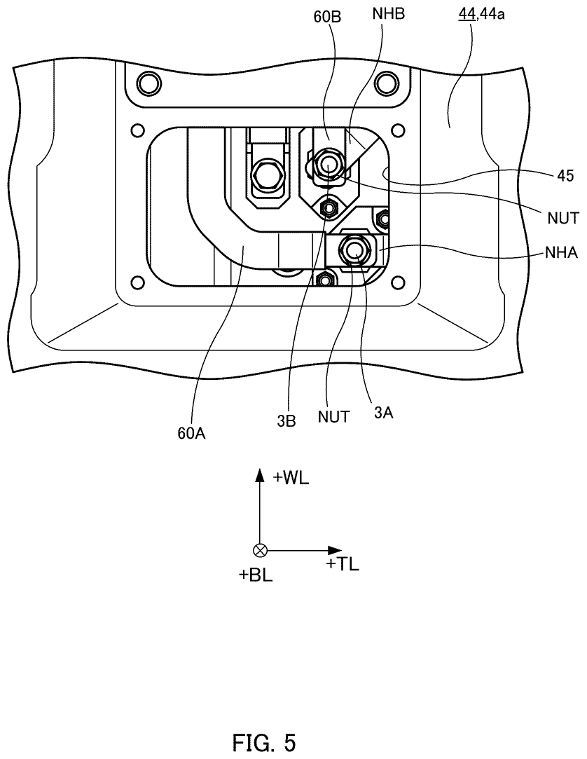

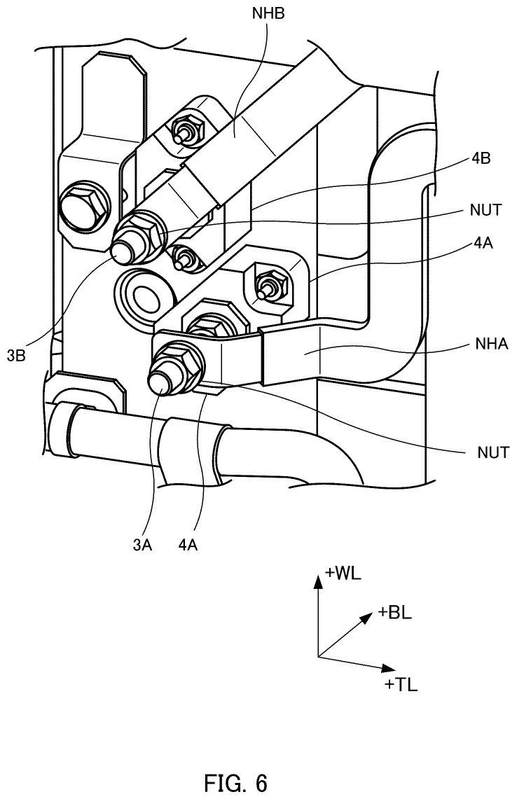

Next, the location of opening part 45 will be described with reference to FIGS. 4, 5, and 6. FIG. 4 is a view illustrating a bus bar and a terminal that are visible through an opening part in the embodiment of the present disclosure. FIG. 5 is a view illustrating a bus bar, a terminal, and a fastener that are visible through an opening part in the embodiment of the present disclosure. FIG. 6 is a perspective view illustrating a bus bar, a terminal, and a fastener in the embodiment of the present disclosure.

As illustrated in FIGS. 4, 5, and 6, in a case where battery cover 40 is assembled to battery case 30 such that accommodation part 32 is covered from the front surface side (−BL direction) by front surface side wall part 44 (front surface panel 44a), opening part 45 is disposed in a position where terminals 3A and 3B are visible through opening part 45 from the outer surface side of front surface side wall part 44. As described above, opening part 45 is disposed at a position where one end portion of bus bar 60A (end portion on the side connected to terminal 3A) is disposed, and at a position where one end portion of bus bar 60B (end portion on the side connected to terminal 3B) is disposed. Thus, in a case where battery cover 40 is assembled to battery case 30, the worker can visually recognize bus bar 60A and terminal 3A through opening part 45, and can visually recognize bus bar 60B and terminal 3B. In other words, opening part 45 is disposed at a position in which bus bars 60A and 60B and terminals 3A and 3B are accommodated, and has a size in which bus bars 60A and 60B and terminals 3A and 3B are accommodated.

### Battery Assembly Work

Next, a battery assembly work in the present embodiment will be described. Note that the battery assembly work includes a wiring work, which is a work of electrically connecting terminal 3A and bus bar 60B and electrically connecting terminal 3B and bus bar 60B. Further, in the battery assembly work, in a case where opening part 45 is closed by a lid (not illustrated), the lid is removed from opening part 45 in advance such that opening part 45 is open (see FIG. 2).

First, battery pack 2 is accommodated in accommodation part 32. Battery pack 2 is accommodated in accommodation part 32 from the upper side (+WL direction) of accommodation part 32.

Next, battery cover 40 is assembled to battery case 30 such that accommodation part 32 (battery pack 2) is covered from the front surface side (−BL direction) by front surface side wall part 44 (front surface panel 44a).

Note that, in a case where battery cover 40 is assembled to battery case 30, accommodation part 32 (battery pack 2) is covered from the back surface side (+BL direction) by back surface side wall part 42. Further, accommodation part 32 (battery pack 2) is covered by upper side wall part 46 from the upper side (+WL direction). Further, in a case where battery cover 40 is assembled to battery case 30, the position of opening part 45 and the positions of bus bars 60A and 60B and terminals 3A and 3B face each other in the depth direction (BL direction). In other words, the worker can visually recognize each of bus bars 60A and 60B and terminals 3A and 3B through opening part 45 from the outer surface side of front surface side wall part 44.

Note that, when battery cover 40 is assembled to battery case 30, fitting part 62A of bus bar 60A may be fitted to terminal 3A at the same time, and fitting part 62B of bus bar 60B may be fitted to terminal 3B at the same time (see FIG. 4). In the battery assembly work in the present embodiment, fitting part 62A does not fit into terminal 3A simultaneously, but fitting part 62A is positioned in the vicinity of terminal 3A. Further, fitting part 62B does not fit into terminal 3B simultaneously, but fitting part 62B is positioned in the vicinity of terminal 3B. This makes it possible to clarify to the worker the correspondence relationship (connection relationship) between fitting part 62A and terminal 3A, and the correspondence relationship (connection relationship) between fitting part 62B and terminal 3B.

Next, terminal 3A and bus bar 60A are electrically connected to each other while being visually recognized through opening part 45 from the outer surface side of front surface side wall part 44. Specifically, fitting part 62A is fitted to terminal 3A from the upward direction (+WL direction) (see FIG. 4), and terminal 3A and bus bar 60A are fastened to each other by a nut screwed into the screw part. Further, terminal 3B and bus bar 60B are electrically connected to each other while being visually recognized through opening part 45 from the outer surface side of front surface side wall part 44. Further, specifically, fitting part 62B is fitted to terminal 3B from the upward direction (+WL direction) (see FIG. 4), and terminal 3B and bus bar 60B are fastened to each other by a fastener (nut) screwed into the screw part (see FIGS. 5 and 6).

Next, opening part 45 is closed with a lid (not illustrated). Thus, the battery assembly work in the present embodiment is completed. The wiring work of electrically connecting terminal 3A to bus bar 60B and electrically connecting terminal 3B to bus bar 60B is also completed.

The battery assembly structure in the above embodiment includes: battery case 30 including accommodation part 32 that accommodates battery pack 2; battery cover 40 including front surface side wall part 44 that covers accommodation part 32 from the front surface side and includes opening part 45 extending through front surface side wall part from the front surface side (−BL direction) to the back surface side (+BL direction); and bus bars 60A and 60B disposed at a position on the inner surface side of front surface side wall part 44 and at a position visible through opening part 45 from the outer surface side of front surface side wall part 44. In a case where battery cover 40 is assembled to battery case 30 such that accommodation part 32 is covered from the front surface side by front surface side wall part 44, opening part 45 is disposed at a position where bus bars 60A and 60B and terminals 3A and 3B are visible through opening part 45 from the outer surface side of front surface side wall part 44.

With this configuration, in a case where battery cover 40 is assembled to battery case 30, the worker can visually recognize bus bar 60A and terminal 3A through opening part 45, and can also visually recognize bus bar 60B and terminal 3B. Therefore, the worker can perform the connection work (wiring work) for electrically connecting bus bar 60A and terminal 3A and the connection work (wiring work) for electrically connecting bus bar 60B and terminal 3B under sufficient conditions for the wiring works. As a result, it is possible to perform the wiring work easily without mutual interference or damage between the bus bar and the terminal.

Further, in the battery assembly structure in the above embodiment, terminals 3A and 3B are provided to protrude from battery pack 2 to the front surface side (−BL direction). Thus, since the worker can face terminals 3A and 3B through opening part 45, the worker can further easily perform the connection work (wiring work) of electrically connecting bus bar 60A and terminal 3A, and the connection work (wiring work) of electrically connecting bus bar 60B and terminal 3B.

Further, in the battery assembly structure in the above embodiment, bus bars 60A and 60B include concave grooves that are recessed in the upward direction (+WL direction) such that bus bars 60A and 60B are fittable to terminals 3A and 3B from the upward direction. Thus, when battery cover 40 is assembled to battery case 30, it is possible for fitting part 62A of bus bar 60A to be fitted to terminal 3A simultaneously and for fitting part 62B of bus bar 60B to be fitted to terminal 3B simultaneously. Further, even in a case where fitting part 62A is not fitted to terminal 3A simultaneously or fitting part 62B is not fitted to terminal 3B simultaneously, it is possible to clearly indicate the correspondence relationship (connection relationship) between fitting part 62A and terminal 3A and the correspondence relationship (connection relationship) between fitting part 62B and terminal 3B to the worker with fitting part 62A located in the vicinity of terminal 3A and fitting part 62B located in the vicinity of terminal 3B. Therefore, it is possible to further facilitate the connection work of electrically connecting bus bar 60A and terminal 3A and the connection work of electrically connecting bus bar 60B and terminal 3B.

Further, the battery assembly method in the above embodiment is a method of assembling a battery including a battery case 30 including accommodation part 32 that accommodates battery pack 2, battery cover 40 including front surface side wall part 44 provided with opening part 45, and bus bars 60A and 60B disposed at positions on the inner surface side of front surface side wall part 44. The battery assembly method includes: a step of accommodating battery pack 2 in accommodation part 32; a step of assembling battery cover 40 to battery case 30 such that accommodation part 32 is covered from the front surface side by front surface side wall part 44; and a step of electrically connecting terminal 3A disposed in battery pack 2 and bus bar 60A while visually recognizing terminal 3A and bus bar 60A from the outer surface side of front surface side wall part 44 through opening part 45, and electrically connecting terminal 3B disposed in battery pack 2 and bus bar 60B while visually recognizing terminal 3B and bus bar 60B from the outer surface side of front surface side wall part 44 through opening part 45. Thus, in a case where battery cover 40 is assembled to battery case 30, the worker can visually recognize bus bar 60A and terminal 3A through opening part 45 and can visually recognize bus bar 60B and terminal 3B, and thus, can easily perform the connection work of electrically connecting bus bar 60A and terminal 3A, and the connection work of electrically connecting bus bar 60B and terminal 3B.

Note that, in the battery assembly structure in the above embodiment, the accommodation direction of battery pack 2 for accommodating battery pack 2 in accommodation part 32 is set to a direction from the upper side (+WL direction) of accommodation part 32. Further, the assembly direction of battery cover 40 for assembling battery cover 40 to battery case 30 is set to a direction of covering the upper side of accommodation part 32. Further, the installation location of battery connector 50 for installing battery connector 50 in battery cover 40 is front surface side wall part 44 (front surface panel 44a). However, in the battery assembly structure of the present disclosure, the accommodation direction of battery pack 2, the assembly direction of battery cover 40, and the installation location of battery connector 50 are not limited to these. For example, the shape of battery cover 40 (for example, the direction in which accommodation part 32 is open), the installation location of battery pack 2 with respect to the vehicle, the vehicle structure, the specifications of battery pack 2, and the like can be appropriately changed.

Regarding the accommodation direction of battery pack 2 in the present disclosure, in a case where accommodation part 32 is open to the back surface side (+BL direction), battery pack 2 may be accommodated in accommodation part 32 from the back surface side, for example. In this case, battery cover 40 may be assembled to battery case 30 from the back surface side of accommodation part 32. Further, in a case where accommodation part 32 is open to the front surface side (−BL direction), battery pack 2 may be accommodated in accommodation part 32 from the front surface side, for example. In this case, battery cover 40 may be assembled to battery case 30 from the front surface side of accommodation part 32. Further, in a case where accommodation part 32 is open to one side in the width direction (+TL direction), battery pack 2 may be accommodated in accommodation part 32 from one side in the width direction, for example. In this case, battery cover 40 may be assembled to battery case 30 from one side in the width direction of accommodation part 32. Further, in a case where accommodation part 32 is open to the other side in the width direction (−TL direction), battery pack 2 may be accommodated in accommodation part 32 from the other side in the width direction, for example.

Further, the installation locations of battery connector 50, the bus bar, the terminal, opening part 45, and the like in the present disclosure can be appropriately changed according to the shape of battery cover 40 (for example, the direction in which accommodation part 32 is open), the installation location of battery pack 2 with respect to the vehicle, the vehicle structure, the specifications of battery pack 2, and the like. Further, when the installation location of the terminal is changed, the arrangement of power harnesses HNA and HNB for electrically connecting the terminal and the junction box are also changed. For such arrangement changes, battery pack 2 does not need particular changes. In other words, in the battery assembly structure of the present disclosure, assembly structures for various types of batteries can be achieved by changing the shape of battery case 30, the shape of battery cover 40, and the installation locations of battery connector 50, the bus bar, the terminal, and the opening part without changing battery pack 2.

Regarding the installation location of battery connector 50 in the present disclosure, for example, battery connector 50 may be disposed at the back surface side wall part of the battery cover, the one side wall part in the width direction of battery cover 40, or the other side wall part in the width direction. In accordance with the change in the installation location of battery connector 50, the installation locations of the bus bar, the terminal, opening part 45, and the like are also changed. For example, in a case where battery connector 50 is disposed at one side wall part in the width direction of battery cover 40, the bus bar is disposed along the inner surface of the one side wall part in the width direction. Further, the terminal is disposed at one side surface in the width direction of the battery pack. Opening part 45 is disposed at one side wall part in the width direction. Even in this case, the bus bar and the terminal are disposed in a position visible from the outer surface side of the one side wall part in the width direction through opening part 45.

Each of the above-described embodiment merely shows an example of specific implementation of the present disclosure, and the technical scope of the present disclosure should not be construed to be limited thereto. That is, the present disclosure can be implemented in various forms without departing from its spirit or key features.

### INDUSTRIAL APPLICABILITY

The present disclosure is suitably utilized in a vehicle including a battery assembly structure for which it is necessary to easily perform a connection work of electrically connecting a bus bar and a terminal.

1. A battery assembly structure comprising:
a battery case including an accommodation part configured to accommodate a battery pack;
a battery cover including a wall part covering the accommodation part, and an opening part extending through the wall part;
a connector disposed on an outer surface side of the wall part; and
a bus bar disposed on an inner surface side of the wall part and configured to electrically connect the connector and a terminal disposed in the battery pack, wherein
in a case where the battery cover is assembled to the battery case such that the accommodation part is covered by the wall part, the opening part is disposed in a position in which the bus bar and the terminal are visible through the opening part from the outer surface side of the wall part.

2. The battery assembly structure according to claim 1, wherein the terminal protrudes from the battery pack.

3. The battery assembly structure according to claim 1, wherein the bus bar includes a recess part that is recessed in an upward direction such that the bus bar is fittable to the terminal from the upward direction.

4. A battery assembly method of assembling a battery including a battery case including an accommodation part configured to accommodate a battery pack, a battery cover including a wall part and an opening part provided in the wall part, and a bus bar disposed at a position on an inner surface side of the wall part, the method comprising:
accommodating the battery pack in the accommodation part;
assembling the battery cover to the battery case such that the accommodation part is covered by the wall part; and
electrically connecting the bus bar and a terminal disposed in the battery pack while visually recognizing the bus bar and the terminal through the opening part from an outer surface side of the wall part.
